(19) United States
(12) Patent Application Publication
(10) Pub. No.: US 2003/0013532 A1
(43) Pub. Date: Jan. 16, 2003

(54) Method and apparatus for providing information via gaming machine player tracking device

(76) Inventors: Rick Rowe, Henderson, NV (US); Jeff Shepherd, Reno, NV (US)

Correspondence Address: R. Scott Weide, Weide & Miller, Ltd., 11th Floor, Suite 1130, 330 South 3rd Street, Las Vegas, NV, 89101, US

(21) Appl. No.: 10/242,559

(22) Filed: Sep. 11, 2002

Related U.S. Application Data
(63) Continuation-in-part of application No. 09/965,786, filed on Sep. 27, 2001.
Application No. 09/965,786 is a continuation-in-part of application No. 09/903,095, filed on Jul. 10, 2001.

(51) Int. Cl. A63F 13/00

(52) U.S. Cl. 463/42

(57) ABSTRACT

The invention is a system and method for disseminating information via a player tracking device of a gaming machine. In one embodiment, an information host generates information and transmits it to the player tracking device of a gaming machine over a communication link. The information is presented at the gaming machine via the player tracking device, such as a video display thereof. The information may comprise advertising, promotion, bonus, and multi-media information such as lights, sounds and images, either still images or video clips or streaming/continuous video, and may be presented independent of activities occurring at the gaming machine. In one embodiment, the information is transmitted over a communication link which forms a portion of a player tracking network including a player tracking host and the gaming machine.

### RELATED APPLICATION DATA

This application is a continuation-in-part application of U.S. application Ser. No. 09/965,786 filed Sep. 27, 2001, which is a continuation-in-part of U.S. application Ser. No. 09/903,095 filed Jul. 10, 2001.

### FIELD OF THE INVENTION

The present invention relates to a system and method by which information may be provided to a gaming machine via a player tracking device thereof.

### BACKGROUND OF THE INVENTION

Casinos and other game operators continually seek new ways to reach players to advertise the various goods and services of the casino, such as to entice the players to play their games, attend shows and the like. In some arrangements, this information may be presented to a player by advertising, printed flyers and the like. In some instances, the information may include promotions.

These methods of providing information to players or prospective players have numerous drawbacks. First, it is difficult to target specific information to specific players or a group of players, if such is desired. For example, a high price must be paid for a newspaper or radio ad which is distributed widely, when only a small number of the people exposed to the ad are desired recipients.

In some instances, targeted advertising is utilized. For example, players which are members of a player rewards program at a casino may be sent flyers regarding promotions. This type of advertising still has drawbacks. Among other things, the information generally must be sent to the player far in advance of the promotion or event, and only reaches the player at their residence.

Within a casino, flyers, posters and the like may be utilized to provide information. These means of distributing information also suffer drawbacks, such as not being easily updated and not being exposed to players at all times.

A convenient and effective means for providing information to players and prospective players of gaming machines and other customers of casinos and similar environments is desired.

### SUMMARY OF THE INVENTION

The invention comprises methods and systems for disseminating information at a gaming machine by directing information to a player tracking device associated with the machine.

In one embodiment, a system includes a gaming machine, a player tracking system, and an information host. The player tracking system comprises a player tracking device at the gaming machine, and may include a remote player tracking host and a network by which information may be sent to and from the player tracking device and player tracking host for tracking player game play and awarding rewards. In one embodiment, the player tracking device includes a player tracking device controller and one or more peripherals, such as a card reader, display, keyboard, printer and speaker.

The information host is configured to generate information and transmit information to the player tracking device of a gaming machine via a communication link. The generated information may comprise advertising, game promotion information, general game play or other goods and services information or the like.

In one embodiment, information is provided to one or more particular players. The information is provided to a particular player or players based upon their identity and one or more criteria.

In one embodiment, the identity of a player is known by the player's use of the player tracking device. Once a player identifies themselves at a gaming machine, the identity of the player and the player's location are known.

In another embodiment, the information is transmitted to and disseminated at the gaming machine regardless of the identity of a player of the gaming machine or activities at the gaming machine. In this embodiment, information is more widely or generally distributed in mass form.

The information may be presented at a gaming machine continuously or periodically. In one embodiment, the information is generated and transmitted, or transmitted from the information host to the player tracking device at predetermined times or time intervals, or upon operator initiated command. In another embodiment, the information may be generated and/or transmitted upon receiving a signal from the gaming machine, such as in response to a period of inactivity at the gaming machine.

In one embodiment, the generated and transmitted information may be stored at the gaming machine. In this embodiment, the information may be presented at predetermined times or time intervals by accessing the information from a memory. The information may also be presented in response to a condition at the gaming machine.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a portion of a gaming machine having associated player tracking system apparatus in accordance with an embodiment of the invention;

FIG. 2 illustrates an player tracking system including a plurality of gaming devices of the type illustrated in FIG. 1;

FIG. 3 illustrates in block-diagram form one embodiment of an implementation of the player tracking system illustrated in FIG. 2; and

FIG. 4 is a flow diagram illustrating a method of providing information to a player in accordance with one embodiment of the present invention.

### DETAILED DESCRIPTION OF THE INVENTION

The invention is a method and system for providing information via the player tracking devices of gaming machines. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

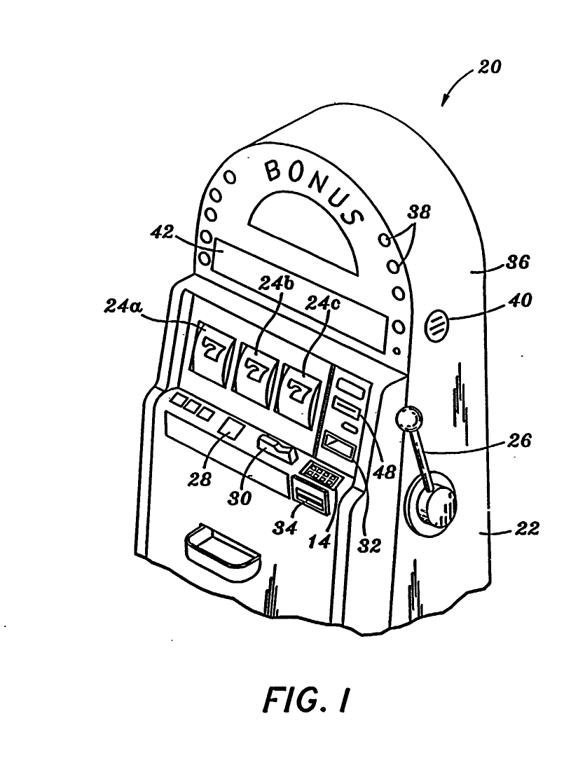

In one or more embodiments, an information system is associated with a gaming system including at least one gaming device. FIG. 1 illustrates one embodiment of such a gaming machine or device 20. In general, the gaming machine 20 is adapted to present at least one game for play to a player. As illustrated, the gaming machine 20 includes a housing 22 which supports and/or houses the various components of the gaming machine 20. In the embodiment illustrated, the gaming machine 20 is adapted to present a game of “slots,” and includes three rotating reels 24a,b,c. A handle 26 or spin button 28 may be used to effectuate rotation of the reels 24a,b,c.

In this well known game, a player may be declared a winner of the game and be awarded an award if the result of the rotation of the reels 24a,b,c is a predetermined combination of symbols. It should be understood that the gaming machine 20 may be adapted to present one or more of a wide variety of games. Depending upon the game presented, the configuration of the machine may vary. For example, in the event the gaming machine 20 is adapted to present the game of video poker, then the gaming machine 20 may include a video display.

In one or more embodiments of the invention, the gaming machine 20 is adapted to present a wager-type game. In this arrangement, a player is required to place a bet or wager in order to participate in the game. In the event the outcome of the game is a winning outcome, then the player may be provided with an award such as coins or currency, or credits which may be redeemed for prizes or money. In one arrangement, the award may be winnings in proportion to the amount wagered or bet by the player.

In order to accept a wager, the gaming machine 20 may include a coin acceptor 30 for accepting coins. The gaming machine 20 may also include a bill acceptor or validator 32 for accepting paper currency. The gaming machine 20 may be provided with other means for accepting or verifying value, such as a credit card reader.

In a preferred embodiment, the gamine machine 20 is associated with a player tracking system. Such a system may also be referred to as a player reward or player loyalty system. The details of this system are described in more detail below. In general the player tracking system includes a gaming machine player tracking device associated with a player tracking host system via a network including a communication link.

One arrangement of a gaming machine player tracking device is illustrated in FIG. 1. As illustrated, the device includes a top box 36 which is located at the top of the gaming machine 20. The top box 36 may have a variety of shapes and sizes. Generally, the top box 36 defines an interior space in which one or more components are located.

In one embodiment, the top box 36 includes a plurality of lights 38 for visual stimulation, at least one speaker 40 for generating audible information, and a bonus indicator 42 in the form of a video display. The lights 38 may be of a plurality of types and be arranged to display in various colors. The bonus indicator 42 may comprise a CRT type display, or an LCD/LED display or the like. As described in more detail below, the bonus indicator 42 may be arranged to display a wide variety of information, including player tracking information and information regarding bonuses.

The player tracking device of the gaming machine 20 also includes a card reader 34 for reading information associated with a player card. The player card may comprise a plastic card including a magnetic stripe. In that arrangement, the card reader may comprise a magnetic stripe reader. The player card may comprise a number of other devices, such as a smart card including a chip.

The player tracking device of the gaming machine 20 also preferably includes a keyboard or keypad 44 which permits input from a player. The keypad 44 is preferably associated with the player tracking function, such as for inputting a player identification or personal identification number (PIN).

The gaming machine player tracking device may have a variety of other configurations and include the other devices. For example, the player tracking device may be fully integrated into the gaming machine and not include a separate top box.

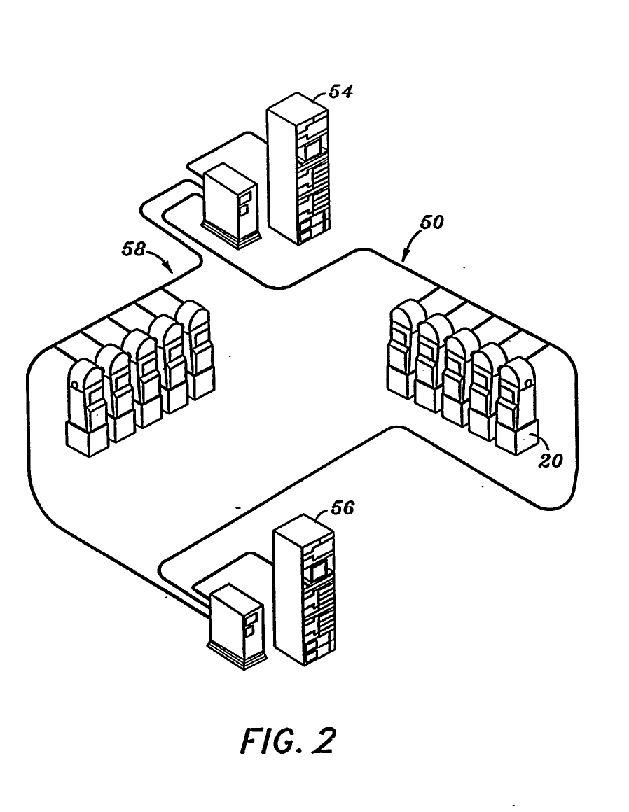

Referring to FIG. 2, in a preferred embodiment, the player tracking device of the gaming machine 20 is associated with one or more other devices through a wired or wireless communication network 58 including at least one communication link. In one embodiment, the player tracking system includes at least one player tracking or reward system host 54. The player tracking or reward system host 54 is in communication with the player tracking device of the gaming machine 20 via the at least one communication link of the network 58.

The player tracking host 54 may comprise a single computer or a group of computers associated with one another on the network 58. Appropriate hardware and/or software is provided for permitting the one or more computing devices of the player tracking host 54 to send and receive information. For example, in one embodiment, data may be sent to and from the player tracking host 54 in accordance with any number of protocols, such as TCP/IP, Ethernet, IEEE-1394, Bluetooth and others. Appropriate hardware and software is provided for implementing these protocols. Of course, the communication protocol and the form of the network 58 are chosen in tandem. For example, the Bluetooth protocol may be implemented with a wireless network 58 including wireless data relay stations. An IEEE-1394 protocol may be implemented over a wired network, such as copper wire or fiber optic lines.

In one embodiment, the player tracking host 54 includes at least one data storage element for storing the player information. The data storage element may comprise a hard drive, RAM, tape drive, CD-ROM, DVD-RAM or other memory or data storage member or element. The player tracking host 54 may including a number of other devices, such as one or more displays, keyboards and other devices for displaying data, controlling operation thereof and the like.

In one embodiment, the player tracking host 54 is adapted to implement a player tracking/reward or “comp” function. The player tracking host 54 may thus be adapted to aggregate game play data regarding various players playing the gaming machines 20. This data may include information such as the length of time of game play, amounts bet, amounts awarded, and a wide variety of other information. In general, the player tracking device of each gaming machine 20 is adapted to transmit the player tracking data over the communications link(s) to the player tracking host 54. Based on player activities, a player may be awarded a “comp”. Comps are generally awards, such as prizes, money, free game play, lodging or the like which are provided to the player apart from any awards which the player receives from direct game play. Such are referred to as “comps” as they are “complimentary” and generally do not require specific obligation, such as an additional bet, in order to be received. The system is often referred to as a reward or loyalty system because a player is generally awarded an award resulting from an extended or frequent game play. In one arrangement, a player may acquire points based upon a game criteria, such as amounts bet, won or lost. If a player accrues sufficient credits, the player is awarded a reward.

FIG. 2 also illustrates an embodiment of an information system 50 in accordance with the present invention. In general, the information system 50 is associated with at least one gaming machine 20. As illustrated, in a preferred embodiment, the information system 50 is associated with a plurality of gaming machines 20. Each gaming machine 20 is arranged to present one or more games to a player and may be of the type described above and illustrated in FIG. 1.

In a preferred embodiment of the invention, the information system 50 is associated with and/or shares certain aspects of the player tracking system. In a preferred embodiment, the information system includes an information system host 56. The information system host 56 may comprise a similar arrangement of hardware to the player tracking host 54. In one embodiment, the player tracking host 54 and information system host 56 may comprise the same device or devices arranged to implement both player tracking and information providing functions in accordance with the invention. As described in more detail below, the information system host 56 is arranged to generate information to be presented to a player of a gaming machine 20.

In general, the information system host 56 is arranged to generate information and transmit the information to the player tracking device associated with a gaming machine 20. The information is transmitted via a communication link of the player tracking network 58. Information may also be transmitted from the player tracking device associated with a gaming machine 20 to the information system host 56. The types of information which may be transmitted are described below.

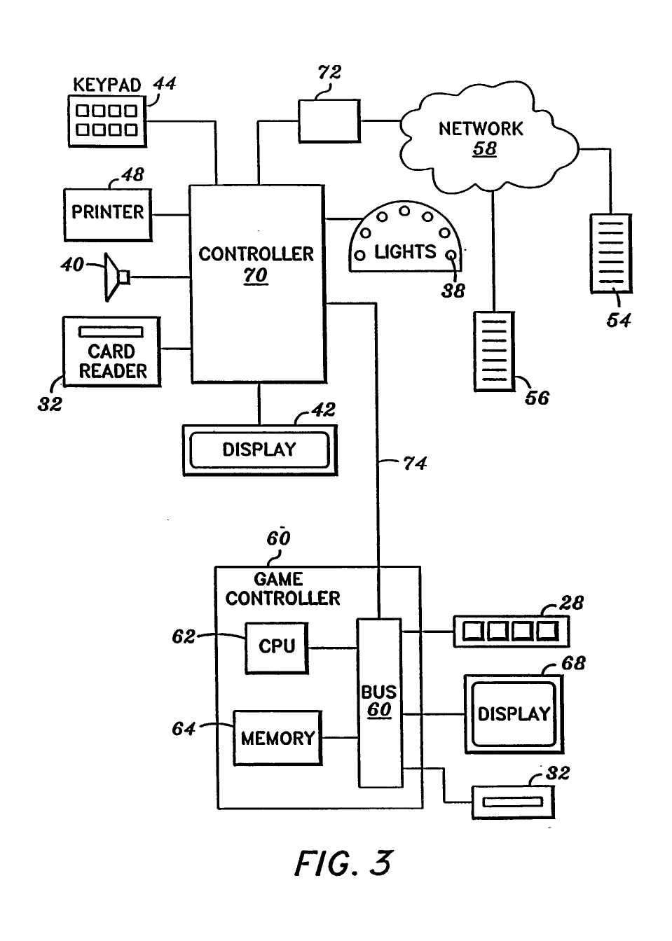

Referring to FIG. 3, there is illustrated a particular arrangement of an information system 50 in accordance with the present invention. As illustrated, the gaming machine 20 includes a gaming machine controller 60. In general, the gaming machine controller 60 is arranged to facilitate the presentation of a game to a player of the gaming machine. In one embodiment, the gaming machine controller 60 includes a processing device 62 and a memory 64 associated with a bus 66. The memory 64 is arranged to store information, such as game software/code for execution by the processing unit 62. The processing unit 62 outputs instructions/data through the bus 66 for controlling one or more peripheral devices of the gaming machine for presenting the game. As illustrated, the peripheral devices may include a display 68. In the case of a slot game, the display 68 may comprise one or more reels. In the case of video poker and other games, the display 68 may comprise a CRT, LCD or the like. Other peripherals may include the above-referenced keys or buttons for accepting user input, and a coin acceptor/bill validator. The gaming machine controller 60 may be located in an internal portion of the gaming machine. In general, the arrangement of a gaming controller and its method of operation in presenting a game is well known.

The player tracking device associated with the gaming machine preferably includes a control device. In general, the control device is adapted to execute instructions/perform tasks, and transmit information or data from the gaming machine to a remote location via the player tracking system network 58. As part of the tasks, the control device is adapted to control one or more peripheral devices, such as the lights 38 and printer 48.

In one embodiment, the control device comprises a slot management interface board (SMIB) 70. The SMIB 70 may have a variety of forms and configurations. In one embodiment, the SMIB 70 comprises a circuit board having circuits configured to execute or implement a variety of instructions/tasks.

In one embodiment, the SMIB 70 is arranged to control or interface with one or more peripheral devices. In a preferred embodiment, these devices include the bonus indicator or display 42, the keypad 44, the card reader 34, the lights 38, the at least one speaker 40, and the printer 48. The SMIB 70 and the peripheral devices may be arranged to communicate using a variety of protocols, such as USB, serial or parallel.

In one embodiment, the SMIB 70 is housed in the top box 36 of the player tracking device associated with the gaming machine 20. The SMIB 70 may be located elsewhere, however, such as within the gaming machine when the player tracking device is integrated with the machine.

As illustrated in FIG. 3, a communication interface 72 is provided between the SMIB 70 and the player tracking system network 58. The communication interface 72 may comprise a wide variety of devices. For example, the communication interface 72 may comprise a modem or a PC type card including an antennae for implementing a wireless communication protocol such as Bluetooth. The communication interface 72 may comprise a PC type card facilitating a protocol over a wired network, such as Ethernet or Firewire®.

Player tracking information is transmitted via the SMIB 70 to the player tracking host 54. In one embodiment, data is transmitted from the SMIB 70 to the network 58 via the communication interface 72. This data is routed to the player tracking host 54.

In one embodiment, the information which is transmitted comprises game play information regarding a player's game play activity. This information may include coins (or other monetary amounts credited), coins paid out, and time of play. In one embodiment, a communication link 74 is provided between the master gaming controller 60 and the SMIB 70 for transmitting this game play information. Game play information from the master gaming controller 60 is transmitted to the SMIB 70 via this link 74. The SMIB 70 may be arranged to manipulate the transmitted information, such as by changing its form for transmission to the player tracking host 54. In a preferred embodiment, the communication link 74 operates by a proprietary protocol which permits only limited interaction between the SMIB 70 and gaming controller 60. This proprietary protocol is preferably different than the communication protocol by which the SMIB 70 transmits information to and receives information from the network 58, including the player tracking host 54. In this manner, attempts to tamper with the master gaming controller 60 via access through the network 58 and SMIB 70 are prevented. This ensures the security of the master gaming controller 60.

In one or more embodiments, the SMIB 70 may be arranged to direct information to either or both the player tracking host 54 and the information system host 56. For example, the SMIB 70 may send information regarding a “card in” or “card out” event associated with the card reader 32 of the gaming machine 20 to both the player tracking host 54 and information system host 56. The “card in” event may comprise a player inserting their player card into the card reader 32 of the gaming machine 20. The “card out” event may comprise a player removing their card from the card reader of the gaming machine 20. Other information may be transmitted instead of or in addition to the card in/card out event.

In one embodiment, information may be transmitted from the player tracking host 54 to the information system host 56. For example, the player tracking host 54 may be arranged to transmit a signal to the information system host 56 that a player has activated their account and is playing a particular gaming machine. Information may also be transmitted from the information system host 56 to the player tracking host 54. For example, the information system host 56 may send information regarding a number of credits awarded to a particular player of a gaming machine 20. Also, information may be transmitted from the player tracking device of a gaming machine 20 directly to the information system host 56.

Further aspects of the player tracking function(s) will now be described. In one embodiment, an account is created for each user of the player tracking system. In order to participate in the reward or tracking system, a player may be required to provide certain information, including identification information. This may be provided by filling out a request form providing the information. A casino or other gaming machine operator may then generate an account for that player. The player's account information may be stored at a data storage device of the player tracking host.

The player is issued a player tracking card or other media. This card includes identification information, such as a unique player identification code. When a player wishes to play the gaming machine, the player inserts their player tracking card into the card reader 34. The card reader 34 reads the player identification code. This code is transmitted to the player tracking host 54 via the SMIB 70 and the player tracking system network 58. Insertion of the card and transmission of the identification code may be used to identify the start of a game player session of that particular player.

In one embodiment, in response to receiving the identification code, the player tracking host 54 may send a prompt requesting that the player input a personal identification number (PIN) or other code. The prompt from the player tracking host 54 may cause the SMIB 70 to cause the display 42 to display a request to the player that the player input their PIN.

A player may input their PIN using the keypad 44. The PIN is transmitted to the player tracking host 54 where it is verified against a PIN stored in association with the player's identity. If the player's PIN is correct, then an indication of such may be provided, and an instruction that the player may begin game play may be provided. Game play activity data may thereafter be obtained and transmitted to the player tracking host 54. The game play activity data may be manipulated and stored. In one embodiment, the player tracking host 54 may be arranged to associate information with the player's account. This information may comprise awarded points which may be redeemed for prizes or awards, such as free game play.

Of course, the player tracking system may have a wide variety of features other than or different than those described herein. Further, the player tracking system may be arranged in a wide variety of configurations and include other components that described herein.

Additional details of the information system 50 will now be described, still with reference primarily to FIG. 3. In a preferred embodiment, the information system 50 is arranged to generate information and disseminate the information via the player tracking device of one or more gaming machines 20.

The information system host 56 is arranged to generate information. The information may be of a wide variety of types. In one embodiment, the information may pertain to a particular player. For example, the information may comprise information regarding the player's account, such as the number of points which the player has accrued in their player tracking account.

The information may comprise advertising. The advertising may pertain to a wide variety of goods and/or services. For example, the advertising may regard games, shows and other events or activities. These events or activities may be associated with the casino where the gaming machine is located, or elsewhere. The advertising may pertain to goods, such as food.

The information may comprise general information, such as show times, restaurant hours, particular menu items at restaurants, pricing, seating availability and the like. The information may also comprise “public service” information such as safety notices, notices regarding non-smoking areas, that only players of authorized age may play gaming machines and the like.

In one embodiment, the information pertains to the casino or other location where the gaming machine is operated. For example, the casino at which the gaming machine is located may disseminate the information to advertise its own products and services.

The information may also pertain to the goods and services of others. For example, large companies selling products such as cars, homes, clothing and the like may disseminate advertising in the manner described. In some events, the casino or other entity may be paid an advertising charge for disseminating the advertising or other information.

The information may be promotion information. For example, the information may indicate that a particular bonus or award is available by playing the gaming machine.

The information may have a variety of forms and comprise other than text. For example, the information may comprise image, such as still image or video, information. The information may also comprise audio or other information.

In one embodiment, the particular information which is generated and transmitted to the gaming machine for dissemination may be dependent upon the gaming machine. For example, the information may vary dependent upon the denomination of the gaming machine (i.e. nickel or quarter minimum bet), type of gaming machine (i.e. slot or video poker) or particular games presented at the gaming machine.

In one embodiment, the information is generated for general dissemination, such as to all gaming machines associated with the system 50. In another embodiment, the information may be directed to one or more gaming machines based upon specific criteria. In another embodiment, the information is generated for specific dissemination to a particular player.

Preferably, the generated information is transmitted from the information system host 56 to the gaming machine 20. In one embodiment, the information system host 56 transmits a signal or data over the network 58 to the SMIB 70. Depending upon the type of information, the SMIB 70 causes the presentation of the information. For example, textual information may be presented on the bonus on the display 42. Audio information may be produced by the speaker 40. Other information may be presented by illumination of the lights 38. In one embodiment, the lights 38 may be caused to illuminate or flash. Video information may be presented on the display 42 associated with the player tracking device of the gaming machine 20 or a separately provided display, or even the main display 68 of the gaming machine 20.

It is noted that in one embodiment, a standard LED display normally associated with the player tracking device of a gaming machine may be replaced with a CRT, LCD, plasma or other display capable of presenting high resolution images (still or moving), such as from NTSC or PAL compatible signals, JPEG or other image data formats.

As indicated, in one embodiment, information is directed to a particular player or players. In accordance with this embodiment, the identity of the player or players to whom information is to be directed may be determined from a player's identification as determined through the player tracking system. In particular, when a player engages in the play of a gaming machine 20, the player inserts their player tracking card into the card reader of the player tracking device associated with the gaming machine 20. In one embodiment, when the player's card is inserted, the SMIB 70 is arranged to send a signal of such to the information system host 56. The particular player tracking device or the gaming machine with which the player tracking device is associated may be identified to the information system host 56, such as by a unique code. In another embodiment, the player data is provided to the player tracking host 54. Player information may then be transmitted from the player tracking host 54 to the information system host 56.

The information system host 56 may then transmit information to that particular player using the gaming machine identification information. As is known in the art of communications, the information system host 56 may send packetized information including a destination header which dictates that the information only be directed to or be accepted by the device at the intended destination, such as a particular player tracking device associated with a particular gaming machine.

In one or more embodiments, the time when information is provided and the content or type of information which is provided to a player may be determined by one or more criteria. Preferably, those criteria are dependent upon the player. For example, the criteria may comprise a number of points that the player has accrued in the player reward account. The criteria may comprise a length of time of play, amount wagered, amount lost, type of machine played and/or a wide variety of other criteria.

In one embodiment, whether a player meets one or more criteria for obtaining certain information may be determined from player information associated with the player tracking system. For example, the information system host 56 may be configured to send a particular message to each player who has achieved over 10,000 reward points, and another message to each player who has achieved over 20,000 reward points. When a player is identified as playing a gaming machine, the information system host 56 may poll the player tracking host 54 for information regarding the number of reward points belonging to the player. Upon an indication of the number of points belonging to the player, the information system host 56 may send the appropriate message to the gaming machine 20 the player is playing.

The manner by which a player is identified may vary. As described above, such preferably comprises a player providing identification information via a player tracking system. In another embodiment, the identification may come from information provided to a system other than the player tracking system. For example, the gaming machine 20 may include a card reader for reading a credit card. The card reader may be associated with a financial system which allows a player to obtain credit from a remote credit or bank account. In obtaining this credit, the player identifies themselves. Such information may be provided to the information system. As one example, a player may elect to obtain $500 in credit from their credit card through a financial network with which the gaming machine is associated. The request for credit and the player's identity may be provided to the information system host 56. The information system host 56 may be configured to provide a variety of information to that player based upon one or more criteria. For example, the information system host 56 may generate and transmit information regarding a special promotion, which promotion is available to the player as a result of the player seeking at least $500 in credit.

As also indicated, information may be more generally disseminated to a gaming machine or gaming machines without regard to the identity of particular players. In one embodiment, the information may be disseminated based upon specific criteria, such as type of gaming machine, or may be disseminated based upon a variety of criteria, such as particular times or as prompted by a user.

For example, in one embodiment streaming video, video clips, sounds and the like may be presented using the apparatus and system in a manner independent of player play. The information may be presented when the gaming machine is not being played by a player, or when the gaming machine is being played but independent of specific player triggered criteria.

In one embodiment, in the event the gaming machine has not been played for a predetermined period of time, the game controller 60 may provide a signal to the player tracking device controller 70 causing the information to be presented. For example, information regarding the games presented by the gaming machine, information regarding promotions or the like may be presented to entice players to play the gaming machine.

In one embodiment, the information may be presented periodically or continuously. For example, information may be presented every five (5) minutes or at other time intervals. Information may also be presented based upon a particular schedule. For example, particular advertising may be scheduled to be disseminated at particular times, such as advertising for shows during the afternoon, for restaurants in the evening, and for bars or nightclubs at night.

Information may be disseminated based upon an operator-initiated trigger. For example, a user of the system 50 may utilize an input device, such as a mouse of a computer station associated with the information host 56 to cause information to be disseminated. In accordance with this method, the user of the system may direct information at a particular gaming machine or group of gaming machines. The particular information which is disseminated may vary, and may be customized.

As one aspect of the invention, information may be presented when the gaming machine is not in use. This information may comprise, for example, video and audio designed to entice a player to play the gaming machine. Once a player has been detected as playing the machine, such as by insertion of their player tracking card, then different information may be presented. For example, this information may designed to entice the player to play longer. Further, upon certain criteria being met, such as a player's engaging in a particular act, achieving certain levels of reward or the like, then additional different information may be presented. In this manner, a wide range of information is presented based on a wide variety of circumstances or criteria.

It will also be appreciated that whether information is generated and provided, when such information is generated and/or provided, and the type of information which is generated, may vary depending one or more criteria. The manner by which information is generated, including the timing and the like, may be implemented by computer software which is executed by a processing device of the information system host 56.

The type of information which is provided to a player may also vary. As detailed above, such may comprise text, images, sounds or the like. The information may comprise video clips or streaming video (i.e. a moving picture or sequence of images). Video may be presented with or without audio. The information may comprise or include lights, the activation of display elements or presentation of images, designs or the like. The type and nature of the information which is presented may vary dependent in part upon the particular components which are available for presentation, such as speakers, lights, a video display or the like. In a preferred embodiment, the information comprises “multi-media,” i.e. information presented in more than one form such as video and audio. In the system described, the information comprises data which is generated by the information system host 56 and transmitted to the SMIB 70. The SMIB 70 utilizes the information, such as by generating a control signal which is directed to the appropriate peripheral, such as the display 42 or speaker 40.

In the case of text information, the information may be displayed on the display 42. Images, such as still images, video clips or streaming/continuous video may also be displayed on the display 42. Sound may be generated by the one or more speakers 40.

The information may comprise more than identifiable information such as displayed text, “spoken” words or images. For example, the information may comprise music or other sounds having no specific meaning. The information may also comprise light effects, such as the lighting of the lights 38 in randomly or in patterns. In this regard, the information may be characterized as “multimedia,” including sound and image information.

The information provided to the player may be transmitted at the time it is presented from the host 56, or it may be transmitted earlier and stored at a memory device at the player tracking device. For example, in one embodiment, video clips and the like may be transmitted from the information system host 56 to the player tracking device during periods of slow network traffic. When it is desired to present the information, the host 56 may send information in the form of a signal to the player tracking device causing the information to be read from the memory. In another embodiment, the player tracking device memory may be encoded with certain information, such as information which relates to the particular type of gaming machine with which the player tracking device is associated. Again, the host 56 may send a signal to the player tracking device to cause this information to be utilized. Frequently used information may be provided to and stored at the player tracking device over time so that it does not need to be re-transmitted to the player tracking system.

In accordance with one embodiment of the invention, the information system host 56 may be arranged to provide information to gaming machine or devices which are associated with different networks or are at different locations. For example, a group of gaming machines 20 may be located at a first casino and be associated with a player tracking system or network of that particular casino. Another group of gaming machines 20 may be located at another casino and be associated with a player tracking system or network of that casino. The information system host 56 may be in communication with both networks, and thus the gaming machines located at both casinos.

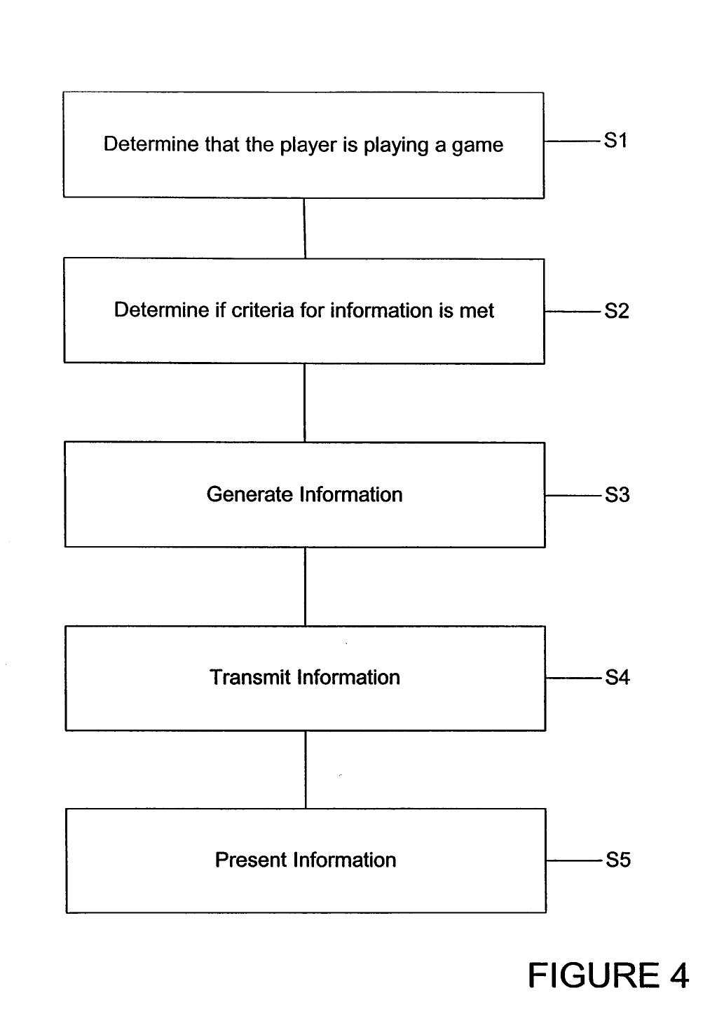

An example of a method of the invention is illustrated in FIG. 4. In a first step S1 it is determined if a player is playing a game, such as on a gaming machines 20. As indicated above, such may comprise a signal from the gaming machine 20 indicating that a player has inserted their player tracking card and including player identification information read from the card.

In a step S2, it is determined if particular criteria are met which entitle the player to receive information. In one embodiment, a single criteria may be applied for determining if a player is entitled to information, or multiple criteria may be applied for determining if a player is entitled to different sets or types of information.

In one embodiment, the criteria may be checked at the time an indication that the player is playing is provided. In another embodiment, the criteria may be checked after game play has begun. For example, a particular promotion may begin at 1 p.m. on Tuesday of each week and may apply to each player who is playing at that time. Though one or more players may have been playing for minutes or hours, the criteria are applied to all playing players at the beginning of the promotion time.

In a step S3, information is generated for providing to one or more players who meet the required criteria. Of course, the information may actually be generated before or after its is determined if the player meets the criteria. For example, in one embodiment, an entire promotion may be programmed into the information system host 56. This promotion may include the information regarding the promotion and the criteria for obtaining the information.

In a step S4, information is transmitted to the player if the player meets the one or more criteria which are requisites for the player to be entitled to the information. As indicated above, this step preferably comprises the transmission of the information from the information system host 56 to the gaming machine 20 via the player tracking network.

In a step S5, the information is presented to the player. As indicated above, this step preferably comprises presenting the information to the player via the display, speaker or other apparatus associated with the player tracking device of the gaming machine 20.

In accordance with the invention, a wide variety of information may be generated and presented. As one example of the breadth of the forms of information which may be generated and provided, the information may comprise a bonus or an opportunity for a bonus. In one embodiment, bonus events are configured by the information system host 56. A variety of bonus events or bonuses may be configured.

In one embodiment, the information system host 56 is configured to generate a bonus for a player of a gaming machine 20. Once a player has identified themselves as playing a particular gaming machine 20 via the player tracking system, the information system host 56 may provide a bonus award to that player. In one embodiment, the information system host 56 is arranged to activate an opportunity for awarding a bonus when a player begins playing a gaming machine. The start of game play may be identified by the player inserting their player tracking card into the card reader of the player tracking device associated with the gaming machine 20.

In another embodiment, game play may be determined by a player providing credits to the machine, such as coins or bills input to the machine. Game play may also be determined by actual game play. In such event, the master gaming controller 60 may be arranged to send a signal regarding the initiation of game play to the SMIB 70, which in turn sends a corresponding signal to the information system host 56.

A variety of specific circumstances or events may be used as criteria for awarding a bonus, including the timing of the bonus and the value of the bonus. In one embodiment, a bonus may be based upon the play information. For example, in the event a player loses a predetermined amount of money, such as evidenced by total coins in compared to total coins out while playing the machine, then the bonus host 56 may be arranged to generate a bonus award for the player. In one embodiment, the information system host 56 may poll the player tracking host 54 to determine the existence of one or more players who satisfy the criteria for a bonus. For example, at predetermined intervals the information system host 56 may poll the player tracking host 54 for the identity of players (as associated with particular player tracking devices of particular gaming machines) who have suffered losses of a certain amount. In another embodiment, the player tracking host 54 may be configured to determine such and directly provide the results of such to the information system host 56. The information system host 56 may be arranged to provide a bonus based on other criteria, such as an indication that a player has placed a certain number of bets, bets in of a certain value, or the like.

In one embodiment, a bonus may be awarded to a player of a game machine 20 randomly. For example, the information system host 56 may include a random number generator, where the selected numbers are associated with a bonus or no bonus, and in the case of a bonus, a bonus amount. In one embodiment, the information system host 56 is arranged to randomly generate bonuses and provide them to active players. As described above, an active player may be identified by their use of a player tracking card or by other events associated with the gaming machine. The timing and size of a bonus is determined by the outcome of the selection of the random numbers.

In one embodiment, a bonus event may be triggered and then a bonus awarded only if one or more events occur thereafter. In this arrangement, bonus information may be generated by the information system host 56 and be transmitted to one or more player tracking devices associated with gaming machines. In a preferred embodiment, the player tracking device is arranged to provide the bonus event information to players or prospective players, such as by the display 42 and/or speaker 40.

In one embodiment, a bonus may be provided to a player based on the player's performance of certain acts. The information system host 56 may transmit bonus event information to one or more of the player tracking devices, and the existence of the opportunity of a bonus may then be disseminated. In one embodiment, the existence of the opportunity for the bonus and the criteria for obtaining the bonus are displayed in text form via the display 42 and/or provided by audible instruction via the speaker 40.

In one embodiment, a bonus may be awarded to a player who performs a certain act. As one example, the bonus may be awarded to the first player to play a particular gaming machine 20 which is presently not being played. In one embodiment, the bonus is awarded to the first player to utilize their player tracking card with the player tracking device associated with the gaming machine 20. For example, the bonus may be awarded to the first player to insert their player tracking card and correctly identify themselves.

In one embodiment, a bonus may be indicated at a machine or group of machines in order to entice greater play at that machine or group of machines. For example, the bonus host 56 may send bonus information to a particular machine or group of machines to entice play. In one embodiment, bonuses may be awarded by the information system host 56 only to a player of a selected machine or to players of a group of machines. The information system host 56 may cause the display of information on the display 42 that a player of the machine may be awarded a bonus while playing that particular machine.

Preferably, when a bonus is awarded, a bonus event occurs which includes a visible and/or audible indication of the award. In one embodiment, the bonus host 56 transmits a signal or data over the network 58 to the SMIB 70 causing the SMIB 70 to display information regarding the bonus on the display 42, to produce audio information via the speaker 40, and illuminate the lights 38. In one embodiment, the lights 38 may be caused to illuminate or flash, and a variety of sounds may be produced by the speaker 40 creating a festive atmosphere.

In one embodiment, the bonus may comprise a monetary award, an award representative of a monetary award, a non-monetary prize or an award representative of a non-monetary prize. In a preferred embodiment, the bonus comprises credits associated with the player's account, which credits may be used for game play or as the basis for another award. For example, in one embodiment, a player utilizing the player tracking system may be awarded points based on their play of a gaming machine. The points may be based upon the total coins in or out, the difference between coins in and out, theoretical win or loss, or other criteria. In any event, a player may be permitted to redeem the points associated with their account for an award. In one embodiment, when a player is awarded a bonus, the bonus may comprise points associated with the player's account.

In one embodiment, a ticket may be dispensed which is representative of money or another type of award. The ticket may be printed and issued utilizing the printer 48 associated with the SMIB 70. The ticket may be redeemable for a prize or monetary award, such as consumer goods, lodging, meals, tokens or the like. The ticket may also comprise a coupon which entitles the player to a reduced price for goods or services. In one embodiment, the ticket may be readable by another device and used in place of money. Such a ticket and a method of using a ticket in lieu of cash is disclosed in U.S. application Ser. No. 09/648,382 which is incorporated herein in its entirety. A ticket may also be printed as a receipt evidencing to a player that an award, such as credits, has been printed.

The information system of the invention may be arranged in fashions other than as described above, and may operate in other manners. For example, in one embodiment the information system may be arranged to award a bonus to a player of a gaming machine regardless of whether the player of that machine is currently identified via the player tracking system. This arrangement has the benefit that while the information system utilizes the player tracking system for providing the bonus, the player who is awarded the bonus need not have a player tracking account or have activated their account during the session of play.

In accordance with the invention, the manner by which the method is implemented, including the manner and form of communication, may vary. For example, the form of the information generated and/or transmitted by the information system host 56 may vary. Depending on the system, the information may be in the form of an analog or digital signal. In one embodiment, a particular signal from the information system host 56 may trigger the execution of certain events by the SMIB 70. For example, the SMIB 70 may be arranged to display certain information in response to one signal, and other information in response to a different signal received from the information system host 56. In another embodiment, the information generated by the information system host 56 may comprise data used by the SMIB 70, such as particular video data which when provided to a video driver causes the display to display certain information.

It will be appreciated that the information system host 56 may be located remote from the gaming machine 20. Further one or more gaming machines 20 which are located remote from one another may be associated with the same information system host 56. The one or more gaming machines 20 may be associated with different gaming properties or operators, or a variety of properties or locations operated by a single party. In such an embodiment, the one or more communication links forming the network 58 may comprise phone lines or the link connecting the properties. For example, the network 58 may form a WAN. In these arrangements, a portion of the wagers placed with gaming machines 20 which are associated with the information system 50 may be used to fund the prizes or bonuses which are awarded via the information system 50.

In accordance with another aspect of the invention, some or all of the information which is generated and provided to a player may be selected by a player. For example, a player who joins a casino's player reward system may be permitted to indicate the type of awards or promotions they would like to receive, when eligible. The player may also indicate a selection of music, images or the like they would like to hear or see while playing a game.

When the player identifies themselves, the information system host 56 may utilize the player's personal selections to generate specific information. For example, the information system host 56 may generate (or obtain, such as from another source) particular sound or music. The music or the like may then be routed to the gaming machine 20 which the player is playing.

It will be appreciated that the system and method of the invention is not limited to that where a gaming machine is provided. For example, player tracking apparatus may be associated with a table game, such as Blackjack. Thus, the invention is applicable to a variety of environments where a game is presented or played, and where appropriate mechanisms (as described above) exist for presenting the information and the like.

The information system and method of providing information in accordance with the present invention has numerous advantages. First, there is provided a information system which may be implemented via an existing player tracking system or other system associated with a gaming machine. The implementation of the information system via another system reduces the amount of time and expense of implementing the information system per se.

As an example, in many instances the master gaming controller of a gaming machine is not associated with a network or system directly. Instead, the master gaming controller is provided with all of the necessary hardware and software for presenting one or more games. The ability to provide information, such as a bonus or award, via an existing system eliminates the need to reconfigure the master gaming controller 60 to do so, including the need to associate the master gaming controller 60 with a communication link.

In one or more embodiments, the information system may be associated with other systems or networks providing communication to the gaming machine. For example, an existing gaming machine may be fitted for credit card use. A credit card reader, controller and communication interface may be associated with the gaming machine, and a communication path established from the interface to a remote location, such as via an installed cable. In accordance with the present invention, the information system may be implemented on this credit card network. Preferably, additional peripheral devices are associated with the credit card controller, such as lights, a display and the like. In another arrangement, a separate information system controller may be provided in communication with the information system host via the communication path/link of the credit card system.

One unique aspect of the invention is that the information system can operate independently of the “game” aspect of the gaming machine, such as independent from the gaming controller. For example, a bonus may be provided which is not directly dependent upon the outcome of the game played at the gaming machine or upon other aspects of play of the game which is presented by the gaming machine. Because of the disassociation of the information system from the gaming machine and the game(s) presented at the gaming machine, a much larger variety of information, such as bonuses and criteria for bonuses may be provided.

The system of the invention allows information to be provided to a player where the information is specific to the player (i.e. “personalized”) or which is specifically directed to the player, and not players in general. The system allows information to be more widely disseminated to players and non-players in mass or widespread manner.

One advantage of the information system is that it may be used to generate play at one or more particular gaming machines. For example, a casino may identify that a particular type of machine or a group of machines in a particular area are experiencing a low play volume. In order to entice greater play of those machines, the casino may provide promotions (such as including promotion instructions) including bonuses to be awarded at those machines using the information system.

Another advantage of the information system is that it may be used to increase the use of a player tracking system. From the perspective of a gaming operator, the advantages of a player tracking system are well known. Player tracking systems provide gaming operators with information which is useful in marketing and in operation. In one embodiment, a player may not be awarded a bonus unless that player is using the player tracking system, either by having an established account or by actually having their account activated while playing a gaming machine. As noted above, in one embodiment, a player may be provided with a variety of different information which is not provided to a player of a game who does not participate in the rewards system. For example, participating players may obtain special information regarding promotions, may be played specific music, or may be awarded a bonus. In these arrangements, a player is enticed to use the player tracking system.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. An information system associated with a gaming system including at least one gaming device, the gaming device arranged to present at least one game for play thereon, comprising:
a player tracking device associated with said gaming device, said player tracking device including a card reader, a keypad, and at least one display, said player tracking device configured to transmit game play information to a player tracking host for use in a player tracking system;
an information system host, said information system host arranged to generate information and transmit the information to the player tracking device associated with said gaming device for dissemination at said gaming device; and
a communication link between said player tracking device and said information system host over which information is transmitted.

2. The information system in accordance with claim 1 wherein said communications link comprises a portion of a player tracking network linking said player tracking device with said player tracking host.

3. The information system in accordance with claim 1 wherein said information system host is adapted to generate information regarding a player promotion.

4. The information system in accordance with claim 1 wherein said information system host is adapted to generate information independent of the play of said gaming device.

5. The information system in accordance with claim 1 wherein said player tracking device includes at least one speaker, said player tracking device arranged to present audible information generated by said information system host.

6. The information system in accordance with claim 1 including a top box mounted upon a housing of said gaming device, said top box supporting at least a portion of said player tracking device.

7. A method of disseminating information at a gaming machine comprising:
providing a player tracking device associated with said gaming machine, said player tracking device including a player tracking device controller and at least one peripheral capable of generating audible or visual information, said player tracking device associated with a player tracking network including one or more communications links permitting transmission of information to and from said player tracking device and a player tracking host;
transmitting information from an information host to said player tracking device over a communication link; and
presenting said information at said gaming machine with said player tracking device.

8. The method in accordance with claim 7 wherein said information comprises video and audio information.

9. The method in accordance with claim 7 wherein said information comprises an advertisement.

10. The method in accordance with claim 7 including the step of storing at least a portion of said information at said player tracking device.

11. The method in accordance with claim 7 wherein said gaming machine includes a gaming machine controller, and including the steps of said gaming machine controller generating a signal, transmitting said signal to said information host, and transmitting said information from said host to said player tracking device in response to said signal.

12. The method in accordance with claim 11 wherein said signal is representative of a period of time said gaming machine has not been played by a player.

13. The method in accordance with claim 11 including the step of storing at least a portion of said information at said player tracking device and including the step of transmitting a signal to said player tracking device to cause said player tracking device to present said information.

14. The method in accordance with claim 7 wherein said step of transmitting is performed at predetermined intervals.

15. The method in accordance with claim 7 wherein said step of transmitting is operator initiated.

16. The method in accordance with claim 7 wherein said step of presenting said information is performed independent of activity occurring at said gaming machine.

17. The method in accordance with claim 7 wherein said peripheral comprises a video display.

18. The method in accordance with claim 7 wherein said peripheral comprises at least one speaker.

19. The method in accordance with claim 7 wherein information which is generated is generated based upon a type of gaming machine to which said information is to be transmitted.
